(19) United States
(12) Patent Application Publication
(10) Pub. No.: US 2009/0150970 A1
(43) Pub. Date: Jun. 11, 2009

(54) Data Fading to Secure Data on Mobile Client Devices

(75) Inventors: Donald W. Hinds, Alpharetta, GA (US); Shari Freeman, Alpharetta, GA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sybase, Inc., Dublin, CA (US)

(21) Appl. No.: 11/950,861

(22) Filed: Dec. 5, 2007

(51) Int. Cl. G06F 21/00

(52) U.S. Cl. 726/1

(57) ABSTRACT

Methods, systems, and computer program products to secure data stored on mobile client devices are provided. In an embodiment, the method operates by defining one or more security policies. Each security policy comprises a plurality of security policy parameters. The method stores the security policies in a data store, and selects a security policy from among the stored security policies for a mobile client device. The selected security policy is applied to the mobile client device. The mobile client device determines whether it is compliance with parameters of said selected security policy, and performs data fade actions if it is determined that it is out of compliance with said security policy parameters.

### BACKGROUND OF INVENTION

1. Field of the Invention

The present invention relates generally to mobile communications technology and more particularly to securing data on mobile client devices. The invention further relates to securing compromised mobile client devices by deleting data and/or decryption keys from the mobile client devices that have been lost or stolen.

2. Description of the Background Art

Mobile client devices are in common usage, many featuring powerful processors, larger and more colorful displays, and wireless networking capabilities. Despite these advances in mobile technology, mobile client devices typically have greater limitations regarding physical and data security than servers and workstation computers. Due to the mobile nature and small size of many mobile client devices, there is a risk that the devices can be misplaced, stolen, or otherwise compromised. As a result of this, data residing on these devices may not remain secure when devices are lost or stolen.

Mobile users face an extremely vulnerable computing environment where security gaps exist. Mobile client devices can include a broad range of hardware and software platforms such as mobile phones, personal digital assistants (PDAs), BlackBerry® devices, Palm® devices, Pocket PCs, Smartphones, hand held computers, palmtop computers, laptop computers, tablet PCs, ultra-mobile PCs, devices running the Symbian mobile operating system, and other wireless client machines. Due to their portability and mobility, mobile client devices can be misplaced, lost, or stolen. When mobile client devices are compromised through loss or theft, the risk of intrusion is high, and existing security controls are inconsistent at best and often unenforceable. On-device data encryption alone is often insufficient to protect data on compromised mobile client devices as regulations regarding data privacy and encryption are becoming stricter. On-device encryption is also less-effective to protect data on mobile client devices as thieves in possession of stolen mobile client devices have the time necessary to derive decryption keys or otherwise access physical data stores on the mobile client devices.

Existing methods to secure data on mobile client devices include allowing users to create a user name and a password associated with the device. When a user name and password have been established for a mobile client device, data stored on the device is available to any user that logs onto the device by furnishing the correct user name and password. Although this approach may restrict access to data, even when the data is encrypted, anyone who obtains the password or the physical module that stores data in a mobile client device may be able to view and copy the data stored therein.

Moreover, when a mobile client device is stolen, thieves may have sufficient time to access data on the device by circumventing on-device security measures such as power-on passwords and on-device data encryption.

Therefore, what is needed is a system, method, and computer program product to secure data stored on mobile client devices in a manner that prevents data access in the event that a mobile client device is stolen or misplaced.

Interaction between mobile client devices and central servers often occurs in the context of periodic updates or exchanges of information stored in databases. Mobile client devices often retain a copy of some or all of the data found in the central database in a local database for local access. However, security gaps exist between the original data residing on corporate servers and local copies stored on mobile client devices due to the limitations of mobile client devices. Additionally, mobile client devices run a variety of operating systems, software suites, and programming frameworks which can limit what on-device security measures can be ‘pushed’ out to the devices.

Given the inherent security risks associated with mobile client devices, what is needed are methods, systems, and computer program product to secure data on these mobile client devices in the event the mobile client devices are lost, stolen, or compromised. Due to the occasionally-connected nature of wireless mobile client devices, what is further needed are data security methods, systems, and computer program products to for mobile client devices, wherein security policies are deployed and enforced within the context of potentially intermittent, unreliable, or unavailable networking capabilities.

Accordingly, what is desired is a means of efficiently securing data residing on compromised mobile client devices. What is further desired are methods and systems to lock (disable), wipe (delete data), or reset a mobile client device that has not communicated with the network or server after a predetermined period of time.

Further, what is needed are methods, systems, and computer program product to render a mobile client device unusable without requiring manual intervention by an organization's information technology (IT) department when a mobile client device is lost or stolen. What is further needed are methods, systems, and computer program product that enable organizations to manage and protect sensitive data, and enforce mobile client data security centrally, rather than placing the burden of security on mobile client end users.

### SUMMARY OF INVENTION

The invention includes systems, methods, computer program products, and combinations and sub-combinations thereof for defining, deploying, changing, and executing a security policy for devices in a mobile environment, wherein the security policy determines when and if a mobile client device will automatically “fade” or delete data located on the device. According to an embodiment of the present invention, “data fading” events can be executed even if a mobile client device is no longer contactable by the central server so that control can be specifically exerted on mobile client devices that have left the IT administrator's control. In this way, data on mobile client devices that are lost, stolen, or compromised can still be protected. According to an embodiment, a lost or stolen mobile client device can be rendered unusable by executing, thus eliminating the need for manual IT intervention for compromised mobile client devices. In accordance with an embodiment of the invention, mobile client devices are “pre-secured” to take data fading actions at a point determined by an IT administrator.

The invention further includes an embodiment for securing email, contact information, and other data on mobile client devices. More particularly, this embodiment allows an information technology (IT) system administrator to define and deploy security policy that controls when a “data fade” will be executed on a mobile client. According to an embodiment of the invention, the mobile device can be locked (disabled), wiped (delete data and/or data decryption keys), or reset (restore mobile client device to original ‘factory’ setting via a hard reset). The embodiment further includes the step of setting type of actions to take (e.g., lock, wipe, or reset the mobile client device) and configuring the event(s) that will trigger the actions (i.e., no communication or connection with network or corporate server after a predetermined period of time and/or entry of a predetermined number of sequential invalid passwords). For example, a security policy may determine that a data fade will execute on a mobile client device when the device has not communicated with a network or security server after a predetermined period of time. An embodiment also includes the step of setting a mobile client to ‘vacation mode’ in order to avoid inadvertent deletion of mobile client data when the user anticipates that the client will be unable to connect to a server for a length of time (i.e., during a vacation out of the service area of the mobile client's wireless service provider).

Unless specifically stated differently, a user or IT administrator is interchangeably used herein to identify a human user, a software agent, or a group of users and/or software agents. Besides a human user who needs to access data on a mobile client device, a software application or agent sometimes needs to access data on mobile devices. Accordingly, unless specifically stated, the term “user” and “administrator” as used herein does not necessarily pertain to a human being. In general, a user and administrator who will access a data on a mobile client device or unlock a device are associated with respective user names and passwords.

The invention additionally includes an embodiment for defining, deploying, changing, and executing a security policy for mobile client devices, wherein the security policy determines when a mobile client device will automatically “fade” or delete data located on the device. According to an embodiment of the invention, the system secures email, contact information, and other data on a mobile client device by “pre-securing” the device to configure the device to perform actions when the device is lost, stolen, or compromised. The system includes a first module to define “data fade” security policies, wherein the policies comprise criterion for determining when a mobile client is “out of compliance”, and wherein the policies comprise actions to take when a mobile client is out of compliance; a second module to store data fade security policies in a data store on a server; a third module to apply a data fade security policy to a plurality of mobile client devices, wherein the updates occur during respective update sessions for the devices; a fourth module to store a data fade security policy securely on a plurality of mobile client devices; a fifth module to periodically test the data fade security policy on one of a plurality of mobile client devices; a sixth module executable on each of the plurality of mobile client devices to determine if the mobile client devices are out of compliance; and a seventh module to take a data fade action when a mobile client device is out of compliance, wherein the data fade action is determined by the data fade security policy stored on the mobile client device.

The invention also includes an embodiment to prevent inadvertent deletion or data fading of email, contact information, and other data on mobile client devices. The embodiment includes a module that avoids inadvertent deletion of data on mobile client devices by allowing a user to set a ‘vacation mode’ on a mobile client device when the user anticipates that the device will be unable to connect to a server for a length of time.

The invention furthermore includes an embodiment to define, deploy, change, and execute a security policy for mobile client devices, wherein the security policy determines when a mobile client device will automatically “fade” or delete data located on the device. The embodiment includes the step of defining “data fade” security policies, wherein the policies comprise criterion for determining when a mobile client is “out of compliance,” and wherein the policies comprise actions to take when a mobile client is out of compliance. The method further includes the steps of storing data fade security policies in a data store on a server; applying a data fade security policy to a plurality of mobile client devices, wherein the policy application occurs during the device's respective update sessions; storing a security policy securely on a plurality of mobile client devices; periodically testing the data fade security policy on the plurality of mobile client devices; determining, on each of the respective mobile client devices, if the mobile client devices are out of compliance; and taking a data fade action when a mobile client device is out of compliance, wherein the data fade action is determined by the security policy stored on the mobile client device.

Moreover, the invention includes a computer program product embodiment comprising a computer usable medium having computer program logic stored thereon for enabling a processor to define data fade security policies, wherein the policies comprise criterion for determining when a mobile client is out of compliance, and wherein the policies comprise actions to take when a mobile client is out of compliance. The computer program product further comprises computer program logic, which when executed, enables a processor to store security policies in a data store on a server; apply a security policy to a plurality of mobile client devices during the respective update sessions for each device update session; store security policies securely on a plurality of mobile client devices; periodically test compliance with the security policies on each of the plurality of mobile client devices; determine if a mobile client device is out of compliance; and execute a data fade action when a mobile client is out of compliance, wherein the data fade action is determined by the security policy stored on the mobile client device.

The invention also includes a computer program product embodiment comprising a computer usable medium having computer program logic recorded thereon for enabling a processor to prevent inadvertent deletion or data fading of email, contact information, and other data on mobile client devices. The computer program logic includes computer program logic that enables a processor to avoid inadvertent deletion of data on mobile client devices by allowing a user to set a ‘vacation mode’ on a mobile client device when the user anticipates that the device will be unable to connect to a server for a length of time.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The present invention is described with reference to the accompanying drawings. The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a mobile data system, in accordance with an embodiment of the present invention.

FIG. 2 illustrates a mobile data system with two mobile client devices disconnected from the network, wherein one is compromised (i.e., lost or stolen) and a second is set to vacation mode, in accordance with an embodiment of the invention.

FIG. 3 depicts the steps by which data residing on compromised mobile client devices is secured, in accordance with an embodiment of the present invention.

FIG. 4 illustrates the definition, deployment, and execution of mobile data security policies, in accordance with an embodiment of the present invention.

FIG. 5 is a flowchart illustrating steps by which mobile data security policies are defined, deployed, and executed on mobile client devices, in accordance with an embodiment of the present invention.

FIG. 6 depicts an example computer system in which the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The present invention relates to systems, methods, and computer program products for securing data residing on mobile client devices that have been lost, stolen, or otherwise compromised. According to embodiments of the invention, data on mobile client devices is secured by defining, updating, deploying, and executing mobile security policies.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The detailed description of embodiments of the present invention is divided into several sections. The first section describes a system for securing data on compromised mobile client devices.

### II. Structural Embodiments

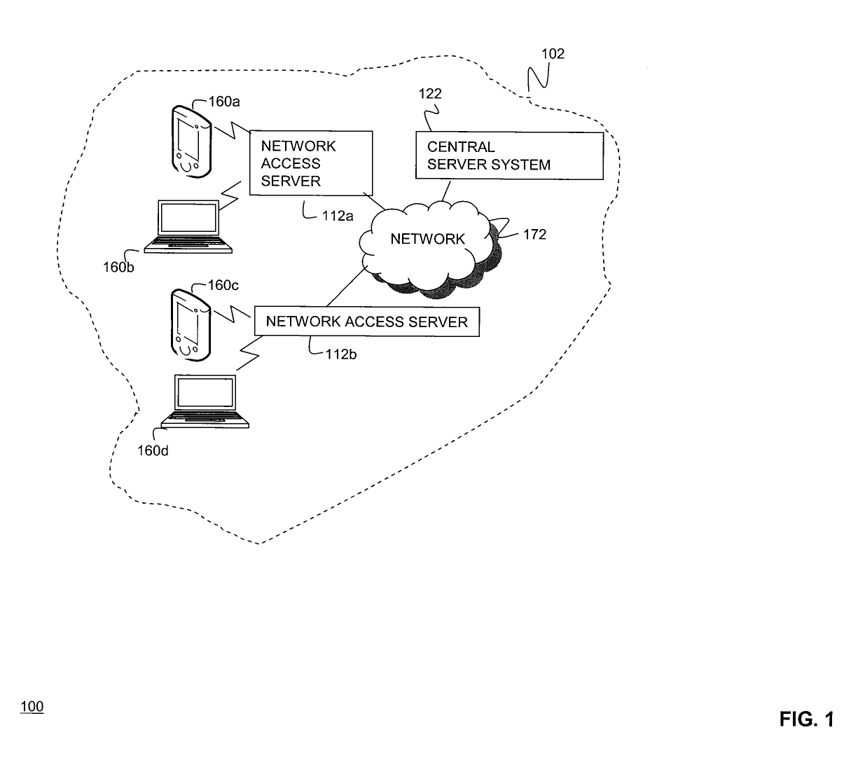

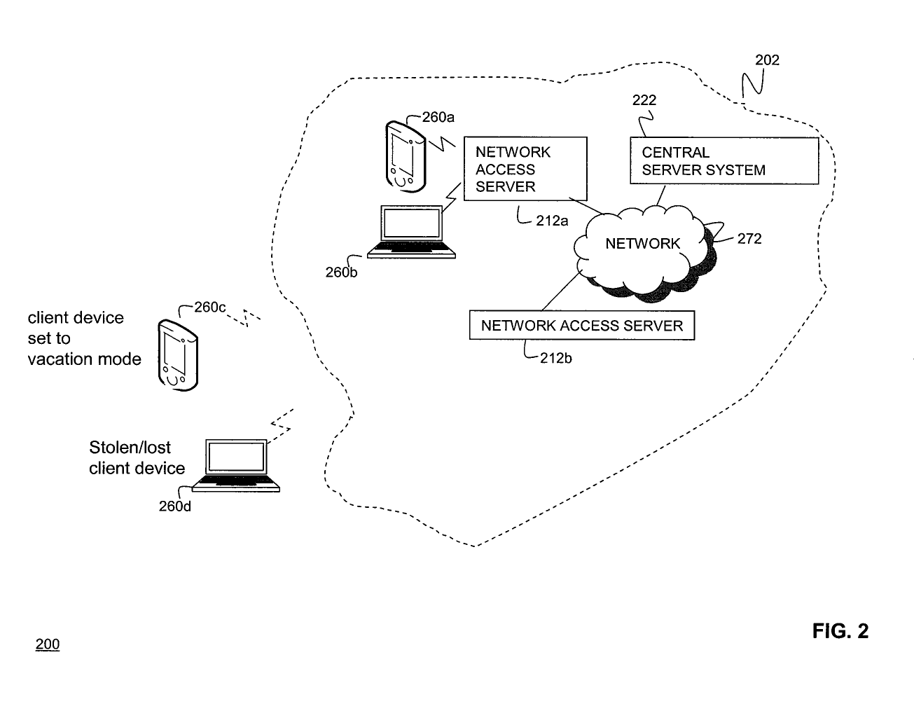

This section describes a system for securing data on mobile client devices according to embodiments of the invention as illustrated in FIGS. 1 and 2.

FIG. 1 depicts a mobile data security system 100 which allows a mobile client devices 160a-d within wireless network 102 to access data on central server system 122 via network 172, in accordance with an embodiment of the present invention. Network access servers 112a and 112b allow mobile client devices 160a-d to receive the most current data available on server system 122, as well as download the most current data fade security policies from a data store on central server system 122. For example, network access servers 112a and 112b can be wireless network access servers used by mobile client devices 160a-d to access central server system 122 via network 172. Central server system 122 applies data fade security policies to mobile client devices 160a and 160b, and the policies are then securely stored on mobile client devices 160a and 160b, according to an embodiment of the present invention. In accordance with an additional embodiment of the present invention, an Information Technology (IT) administrator defines, selects, and updates data fade security policies on system 122 which are stored in a data store on central server system 122. According to an embodiment, security policies are applied to mobile client devices 160a-d during update sessions when the devices connect to network 172 via network access severs 112a and 112b.

In accordance with an embodiment of the invention, mobile client devices 160a-d store security policies securely in their respective data stores. According to an embodiment, the data security policies are stored on mobile client devices 160a-d in a secure manner such that users of mobile client devices 160a-d cannot alter, disable, or delete the security policies. According to a further embodiment, the data fade security policies stored on devices 160a-d may be encrypted to prevent unauthorized alteration of the policies by end-users.

According to an embodiment of the present invention, mobile client devices 160a-d periodically test parameters of data fade security policies stored on devices 160a-d to determine if the client is out of compliance. For example, pursuant to a previously-applied security policy, device 160a will periodically check the elapsed time since the last network connection, number of sequential invalid password entries, and/or elapsed time since the last wireless network connection to determine if the device is out of compliance with the security policy stored on device 160a. According to an embodiment, device 160a may check for non-compliance at regular time intervals (i.e., hourly, daily, weekly, monthly, etc).

In accordance with an embodiment of the invention, mobile client devices 160a-d do not take data fade actions if it has been determined that each of the clients are in compliance with their respective security policies. For example, mobile client device 160c does not take any data fade actions when it determines that device 160c is in compliance with its security policy. According to an embodiment, while device 160c has not been disconnected from wireless network 102 or network 172 for a predetermined period of time, device 160c is in compliance with its security policy and no data fade actions are executed. According to another embodiment, when a predetermined number of sequential invalid password entries have not been made on device 160c, device 160c is in compliance with its security policy and no data fade actions are executed.

“Data” as used herein may be any object, including, but not limited to, information in any form (text, video, audio, etc.) and applications.

Wireless network 102 is commonly, but not limited to, a persistent network connection over a cellular provider network, and communications travel over the Internet. However, system 102 may be any communication means by which central server system 122 and mobile client devices 160a-d may interact, such as a docking cradle, Wide Area Network (WAN), Local Area Network (LAN), Wireless Local Area Network (WLAN), infrared, or Bluetooth. The degree of availability of access to the communication means employed may vary greatly, and a user of mobile client device 160a-d may only occasionally be connected to network 172 (i.e., by using a docking cradle), or may be constantly connectable to central server system 122 when connected to a WAN.

FIG. 2 depicts a mobile data security system 200 in which mobile client devices 260a and 260b are capable of obtaining updated data fade security policies from central server system 122 over network 272 via network access server 212a, in accordance with an embodiment of the present invention. According to the example of FIG. 2, mobile client devices 260c and 260d are no longer capable of obtaining data fade security policies from central server system 222 over network 272 via network access server 212b, but instead retain previously-applied data fade security policies. In this example, client devices 260c and 260d are both disconnected from the network, 260d is compromised (i.e., lost or stolen) and 260c has been set to ‘vacation mode’, in accordance with an embodiment of the invention. Mobile client device 260d may have been lost, stolen, or otherwise compromised such that it can no longer connect to wireless network 202 and network 272.

In accordance with an embodiment of the invention, mobile client devices 260c and 260d periodically test parameters of their respective, locally-stored data fade security policies to determine if they are out of compliance. For example, pursuant to a previously-applied security policy, device 260c will periodically check the elapsed time since the last network connection, number of sequential invalid password entries, and/or elapsed time since the last wireless network connection to determine if device 260c is out of compliance with its locally stored security policy. According to an embodiment, device 260c may check for non-compliance at regular time intervals (i.e., hourly, daily, weekly, monthly, etc).

Assume in the example of FIG. 2 that mobile client device 260c was set to ‘vacation mode’ prior to becoming disconnected from wireless network 202 and network 272. Assume also that device 260d has been lost or stolen. According to an embodiment, in this scenario, device 260c will not take data fade actions despite being disconnected from the network. In contrast, device 260d will test security policy parameters to determine if it is in compliance with its security policy as it was not set to vacation mode. For example, mobile client device 260d takes data fade actions pursuant to its security policy when it determines that it is not in compliance with its locally-stored security policy. According to an embodiment, device 260d will determine that it is not in compliance and will execute data fade actions after it has been disconnected from wireless network 202 and network 272 for a predetermined amount of time (i.e., a certain number of hours, days, weeks, etc.). According to another embodiment, device 260d is not in compliance and will take data fade actions when a threshold number of sequential invalid password entries has been exceeded on the device (i.e., more than n invalid passwords entered on device in a row).

In accordance with an embodiment of the present invention, data fade actions to be performed on mobile client device 260d can include one or more of deleting all data on device 260d, deleting only encrypted data on the device, deleting a subset of data on device 260d which was previously selected by an IT administrator on server system 222, resetting device 260d back to its original factory settings (i.e., a hard reset which returns device 260d back to its original configuration), deleting decryption keys on device 260d, locking mobile client device (i.e., locking the keyboard, screen, and input devices of device 260d) until it is contacted by a server such as 222, locking the device until the device's administrator logs in, or locking the device until a one-time challenge-response process has been completed.

According to a further embodiment, the data fade actions on device 260d cannot be interrupted or overridden by an end-user once device 260d has been determined to be out of compliance with its security policies. In accordance with a further embodiment, data fade actions on device 260d cannot be interrupted by attempting to power down, turn off, or reset device 260d. For example, if a thief in possession of device 260d attempts to circumvent data fade security measures on the device by turning off device 260d, the data fade actions will continue uninterrupted with only the display or screen of device 260d being powered down. Similarly, if a thief in possession of device 260d attempts a hardware reset of the device after recognizing that the data fade actions are executing on the device, data fade actions continue unabated with the screen of device 260d displaying a mock or simulated reset of the device.

In a typical system, mobile client devices 260a-d connect with a central server system 222. Central server system 222 need not be a single physical computer, and may in fact comprise several computers distributed over a number of physical and network locations. For the purposes of illustrations, central servers 122 and 222 are depicted as a single point of access for mobile client devices 160a-d and 260a-d, respectively.

### III. Operational Embodiments

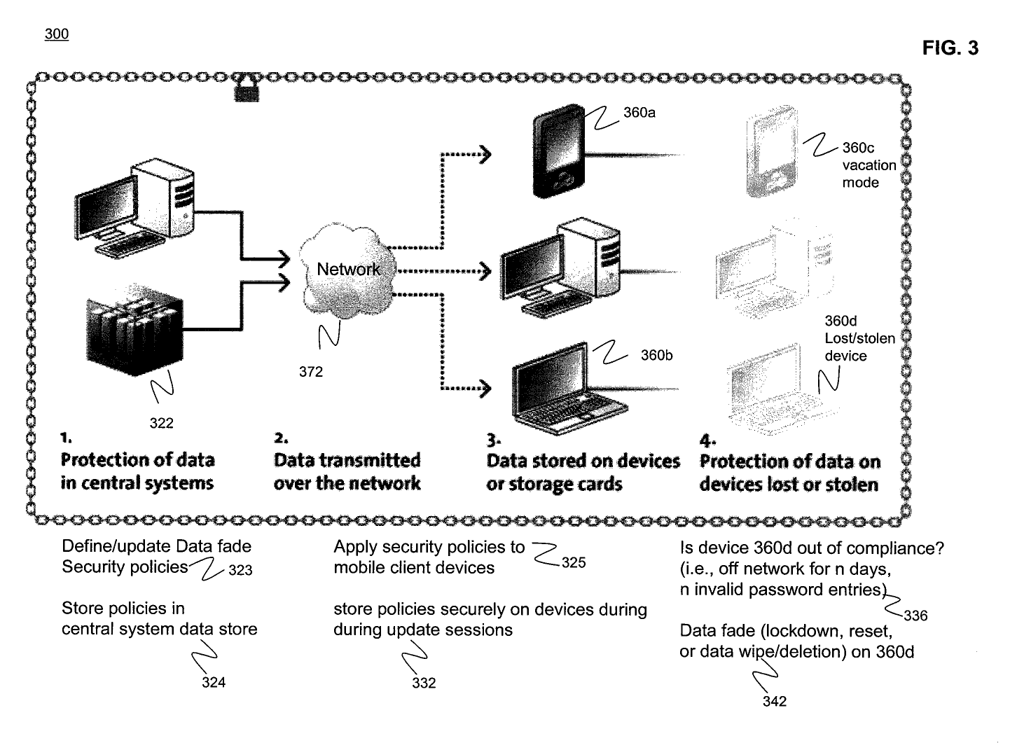

FIG. 3 depicts the steps of method 300 by which data residing on mobile client devices is secured, in accordance with an embodiment of the present invention. The functionality of mobile data security method 300 is described in greater detail in the following sections.

According to an embodiment of the present invention, data fade security policies are defined in step 323, and stored in central system data store 322 in step 324. Security policies are applied to mobile client devices 360a-d in step 325 via network 372 during update sessions for devices 360a-d in step 332. In the example scenario of FIG. 3, devices 360a and 360b remain connected to network 372. Device 360c was set to vacation mode prior to being disconnected from network 372. Device 360d has been lost or stolen and disconnected from network 372.

When mobile client device 360d has been determined to be “out of compliance” with the data fade security policy in step 336, data fade operations (previously stored on the device in step 324) are executed in step 338, in accordance with an embodiment of the present invention.

According to an embodiment, out of compliance criterion for device 360d can include one or more of: passage of a predetermined amount of time (i.e., a number of hours, days, or weeks) since the device 360d was last connected to network 372 or server 322; passage of a predetermined amount of time since device 360d was last updated or “refreshed” with a new security policy; and/or exceeding a predetermined number of invalid login attempts by a user on device 360d.

According to an embodiment of the present invention, once mobile client device 360d has been determined to be out of compliance, data fade actions are taken in step 338. The data fade actions can include, but are not limited to one or more of: deletion of all data on device 360d; deletion of only encrypted data on device 360d; deletion of a subset of data previously selected by an IT administrator in step 323; performing a “hard reset” of device 360d, wherein the hard reset returns device 360d to its factory settings by deleting all data and setting all configuration information back to original factory defaults; deleting decryption keys on device 360d; locking device 360d until device 360d is contacted by server 322, wherein device 360d is locked by disabling the device's keyboard, screen, and input devices; locking device 360d until the device's “administrator” logs in, wherein the device administrator username and password was determined in step 323; or locking device 360d until a one-time challenge-response process has been completed, wherein the challenge-response questions and answers were determined in step 323.

According to an embodiment, the data security policies stored on mobile client devices 360a-d in step 332 are stored in a secure manner such that users of devices 360a-d cannot alter, disable, or delete the security policies. According to a further embodiment, the data fade security policies stored on devices 360a-d in step 332 may be encrypted to prevent unauthorized alteration of the policies by end-users.

According to a further embodiment, the data fade actions on device 360d performed in step 338 cannot be interrupted or overridden by a user once device 360d has been determined to be out of compliance with security policies applied in step 325 and stored in step 332. In accordance with a further embodiment, data fade actions being executed in step 338 on device 360d cannot be interrupted by attempting to power down, turn off, or reset the device. For example, if a thief in possession of device 360d attempts to circumvent data fade security measures on the device by turning off device 360d, the data fade actions will continue uninterrupted with only the display or screen of device 360d being powered down. According to another embodiment of the invention, if a thief in possession of device 360d attempts a hardware reset of the device after recognizing that the data fade actions are executing on the device in step 338, data fade actions continue unabated with the screen of device 360d displaying a mock or simulated reset of device 360d.

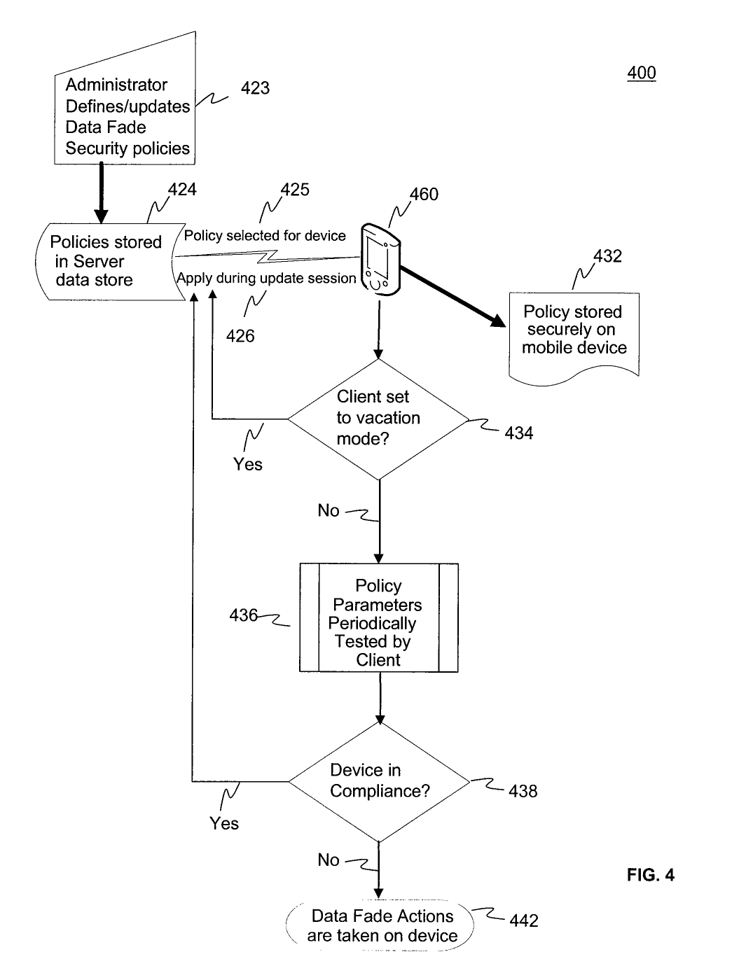

FIG. 4 further illustrates the steps of method 300 by which data residing on mobile client devices is secured, in accordance with an embodiment of the present invention. In step 423, an Information Technology (IT) administrator defines new data fade security policies or updates existing policies.

In step 424, the policies defined and updated in step 423 are stored in a central server data store.

In step 425, a data fade security policy is selected for mobile client device 460, and in step 426 the selected policy is applied during an update session for device 460.

In step 432, the data fade security policy for mobile client device 460 is securely stored in a data store on device 460. According to an embodiment, the data security policy stored on device 460 in step 432 is stored in a secure manner such that users of device 460 cannot alter, disable, or delete the security policy. According to a further embodiment, the security policy stored on device 460 in step 432 may be encrypted to prevent unauthorized alteration of the policies by a user.

In step 434, the vacation mode setting is checked on device 460. According to an embodiment, if device 460 was not set to vacation mode, security policy parameters will be tested (in step 436) to determine if device 460 is in compliance with its security policy. Otherwise, if device 460 was set to vacation mode, security policy parameters pertaining to network connectivity are not tested and, in an embodiment, step 426 is repeated to apply any updates to device 460's security policy during the next update session for device 460. According to an embodiment, even when mobile client device 460 is set to vacation mode, security policy parameters pertaining to the number of invalid sequential password entries will be checked.

In step 436, the security policy parameters are tested by device 460. In accordance with an embodiment of the invention, the frequency of testing or checking of policy parameters is pursuant to the security policy applied in step 426.

According to an embodiment, device 460 will periodically check the elapsed time since the last network connection and/or elapsed time since the last wireless network connection to determine if device 460 is out of compliance with the security policy stored therein. According to an embodiment, device 460 tests for non-compliance at regular time intervals (i.e., hourly, daily, weekly, monthly, etc). In accordance with an embodiment, the number of sequential invalid password entries will be checked to determine if device 460 is out of compliance with the security policy stored therein.

According to an embodiment, device 460 is not considered to be in compliance with its security policy after it has been disconnected from either a wireless network or the network for a predetermined amount of time (i.e., a certain number of hours, days, weeks, etc.). According to another embodiment, device 460 is out of compliance when a threshold number of sequential invalid password entries has been exceeded on the device (i.e., more than n in a row invalid passwords entered on device, wherein n is the maximum allowed number of sequential invalid passwords).

Step 442 is performed if device 460 was determined to be out of compliance. In step 442, data fade actions are taken on device 460. In accordance with an embodiment of the invention the data fade actions in step 438 can include one or more of deleting all data on device 460, deleting only encrypted data on the device, deleting a subset of data previously selected by an IT administrator in step 423, performing a hard reset of device 460 by deleting all data and setting all configuration information back to original factory defaults, deleting decryption keys on device 460, locking device 460 until it is contacted by a corporate server by disabling the device's keyboard, screen, and input devices, locking device 460 until the device's administrator logs in, wherein the device administrator username and password was determined in step 423, or locking device 460 until a one-time challenge-response process has been completed, wherein the challenge-response questions and answers were determined in step 423.

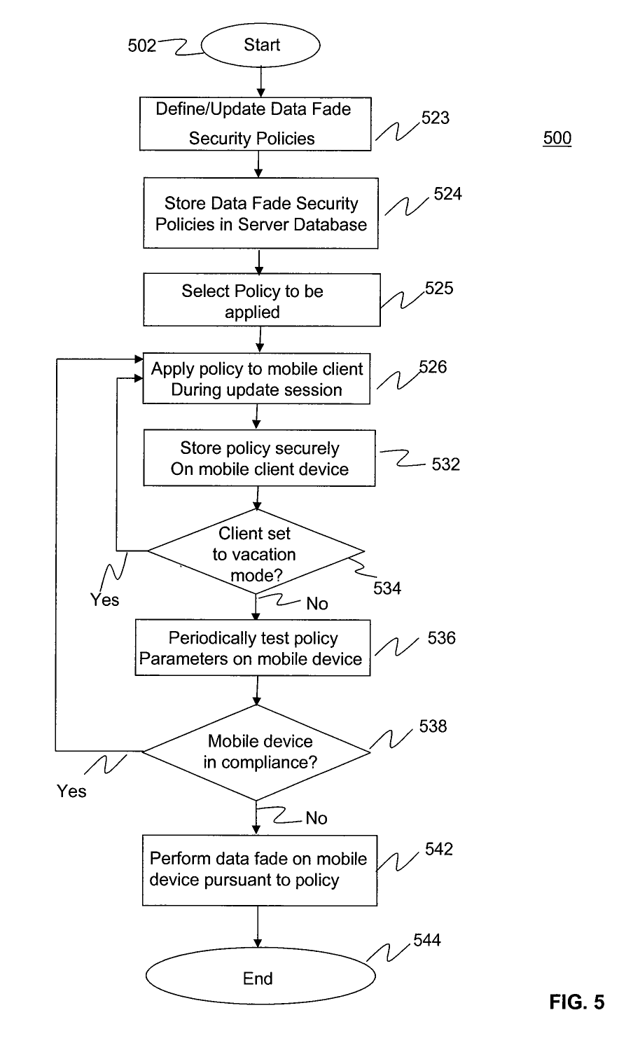

FIG. 5 is a flowchart 500 which illustrates the steps by which the method depicted in FIGS. 3 and 4 secures data on mobile client devices.

The method starts at step 502 and proceeds to step 523. In step 523, an Information Technology (IT) defines new data fade security policies or updates existing policies.

In step 524, the policies defined and updated in step 523 are stored in a central server data store.

In step 525, a data fade security policy is selected for a given mobile client device prior to an update session for the device. According to an embodiment of the present invention, the data fade security policy is selected by an IT administrator before the mobile client device connects as part of the update session.

In step 526 the data fade security policy selected in step 525 is applied to a given mobile client device during an update session for the device. According to an embodiment, the server will apply whatever policy an IT administrator previously specified in step 525 during the update session.

In step 532, the data fade security policy for the mobile client device is securely stored in a data store on the device. According to an embodiment, the data security policy stored on the device in step 532 is stored in a secure manner such that users of the device cannot alter, disable, or delete the policy. According to a further embodiment, the security policy stored on the device in step 532 is encrypted to prevent unauthorized alteration of the policies by an end-user.

In step 534, it is determined if the device is in vacation mode. According to an embodiment, if the device is not in vacation mode, security policy parameters will be tested in step 536 as described below, but if the device is in vacation mode, security policy parameters pertaining to network connectivity are not tested and control returns to step 526. When step 526 is repeated, any updates to the device's security policy will be applied during the device's next update session. In accordance with an embodiment of the present invention, the fact that a mobile client devices has been set to vacation mode does not affect the check for invalid password attempts. For example, if the device's security policy is to lock the device after a number of sequential invalid password entries, the mobile client device will be locked even if the device is in vacation mode.

In step 536, the security policy parameters are tested on the device. In accordance with an embodiment of the invention, the timing and frequency of testing for compliance with security policy parameters is pursuant to the security policy applied in step 525. According to an embodiment, the device will periodically calculate the elapsed time since the last network connection and/or elapsed time since the last wireless network connection to determine if the device is out of compliance with the security policy stored on the device. According to an embodiment, the mobile client device tests for non-compliance at regular time intervals (i.e., hourly, daily, weekly, monthly, etc) pursuant to its security policy.

In accordance with an embodiment of the invention, the check for the number of sequential invalid password attempts is not periodical or based on time interval. For example, the check for the number of invalid password attempts it is done anytime an invalid password is entered on the mobile client device. According to an embodiment, it is number of sequential invalid passwords entered on the mobile client device that triggers a data fade action. For example, a mobile client device will execute data fade actions after n sequential invalid passwords are entered where n is greater than or equal to one.

In step 538, a decision is made as to whether the mobile client device is out of compliance with its security policy parameters or not. According to an embodiment, the mobile client device is not in compliance after it has exceeded a predetermined amount of disconnect time from either a wireless network or a network (i.e., the device has been off of the network for a certain number of hours, days, weeks, etc.). According to another embodiment, the mobile client device is determined to be out of compliance in step 538 when a certain number of sequential invalid password entries have been entered on the device (i.e., more than n consecutive invalid passwords entered on device, wherein n is the maximum allowed number of sequential invalid passwords).

If the device is found to be in compliance in step 538, steps 526-538 are repeated as needed to apply policy updates to the device during subsequent update sessions. The repeated policy selections, applications, and compliance tested are accomplished by repeating steps 526-538. According to an embodiment of the invention, data fade security policies can be updated and stored by repeating steps 523 and 524.

After a compliance decision has been made in step 538, and the device is found to be out of compliance, data fade actions are performed on the device in step 542. In accordance with an embodiment of the invention the data fade actions in step 542 can include one or more of deleting all data on the mobile client device, deleting only encrypted data on the device, deleting a subset of data previously selected by an IT administrator in step 523, performing a hard reset of the device by deleting all data and setting all configuration information back to original factory defaults, deleting decryption keys on the device, locking the device until it is contacted by a corporate server by disabling the device's keyboard, screen, and input devices, locking the device until the device's administrator logs in, wherein the device administrator username and password was determined in step 523, or locking the device until a one-time challenge-response process has been completed, wherein the challenge-response questions and answers were determined in step 523.

After the data fade actions have been performed in step 542, the method ends at step 544.

### IV. Example Computer System Implementation

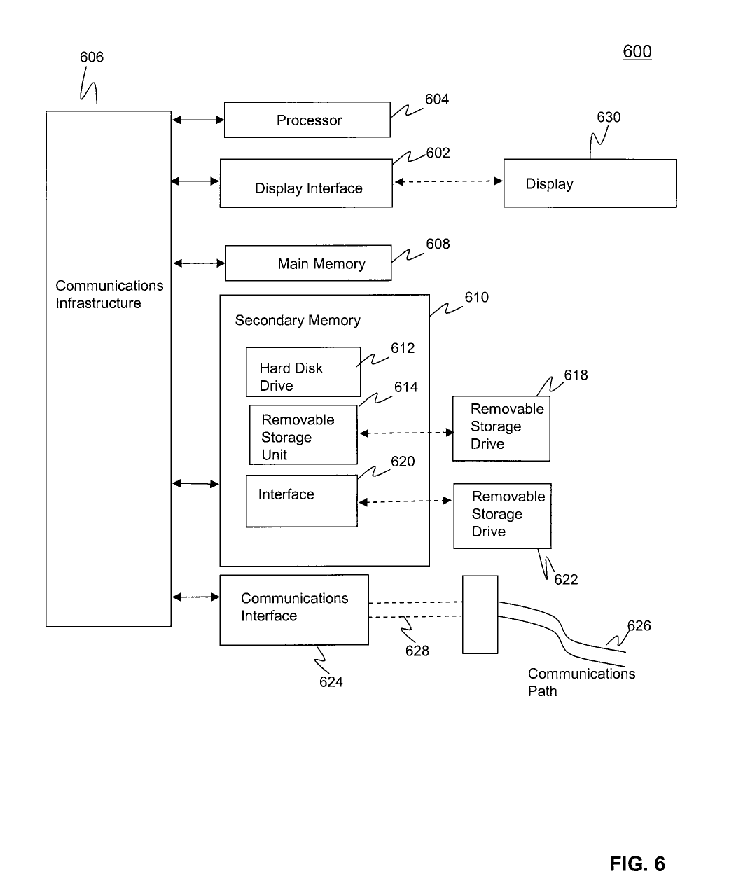

Various aspects of the present invention can be implemented by software, firmware, hardware, or a combination thereof. FIG. 6 illustrates an example computer system 600 in which the present invention, or portions thereof, can be implemented as computer-readable code. For example, the method illustrated by flowchart 500 of FIG. 5 can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communications infrastructure 606 (for example, a bus, or network).

In alternative implementations, secondary memory 610 may include other similar means for allowing computer programs or other instructions to be loaded into computer system 600. Such means may include, for example, a removable storage drive 622 and an interface 620. Examples of such means may include a program cartridge and cartridge interface (such as that found in video game devices), a removable memory chip (such as an EPROM, or PROM) and associated socket, and other removable storage drives 618 and 622 and interfaces 620 which allow software and data to be transferred from the removable storage drive 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 614, removable storage drives 618 and 622, and a hard disk installed in hard disk drive 612. Signals carried over communications path 626 can also embody the logic described herein. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods illustrated by FIG. 3, FIG. 4, and flowchart 500 of FIG. 5 discussed above. Accordingly, such computer programs represent controllers of the computer system 600. Where the invention is implemented using software, the software may be stored in a computer program product and loaded into computer system 600 using removable storage unit 614, interface 620, hard drive 612 or communications interface 624.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The invention can work with software, hardware, and/or operating system implementations other than those described herein. Any software, hardware, and operating system implementations suitable for performing the functions described herein can be used.

### V. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for securing data stored on a mobile client device, comprising:
defining one or more security policies, wherein each security policy comprises at least a plurality of security policy parameters;
storing said security policies in a data store;
selecting a security policy from among said stored security policies for a mobile client device; and
applying said selected security policy to said mobile client device;
wherein said mobile client device determines whether it is compliance with parameters of said selected security policy, and wherein data fade actions are performed on said mobile client device if it is determined that said mobile client device is out of compliance with said security policy parameters of said selected security policy.

2. A method for securing data stored on a mobile client device, comprising:
receiving, at said mobile client device, a security policy, wherein said security policy comprises at least a plurality of security policy parameters, and wherein said security policy is received from a server having stored therein a plurality of security policies;
determining, on said mobile client device, if said mobile client device is in compliance with parameters of said received security policy; and
executing data fade actions on said mobile client device if it is determined that said mobile client device is out of compliance with said security policy parameters.

3. The method of claim 2, wherein said executing step comprises any combination of steps (a)-(f):
(a) deleting all data on said mobile client device;
(b) deleting encrypted data on said mobile client device;
(c) deleting a previously selected subset data on said mobile client device;
(d) performing a hard reset of said mobile client device;
(e) deleting decryption keys on said mobile client device; and
(f) locking said mobile client device, wherein said locking comprises disabling said mobile client device's keyboard, screen, and input devices.

4. The method of claim 3, wherein step (f) further comprises any combination of steps (1)-(3):
(1) locking said mobile client device until it is contacted by a server;
(2) locking said mobile client device until the device's administrator logs in; or
(3) locking said mobile client device until a one-time challenge-response process has been completed.

5. The method of claim 2, further comprising storing said security policy on said mobile client device in a secure manner such that users of said mobile client device cannot alter, disable, or delete said security policy.

6. The method of claim 5, further comprising encrypting said stored security policy.

7. The method of claim 2, wherein said determining step comprises:
testing said security policy parameters periodically.

8. The method of claim 7, wherein said security policy parameters comprise any combination of:
elapsed time since said mobile client device last connected to a network server;
elapsed time since said mobile client device has last had an update session;
number of sequential invalid password entries on said mobile client device; and
elapsed time since said mobile client device last connected to a wireless network.

9. The method of claim 2, wherein said determining step comprises:
determining that said mobile client device is out of compliance when a threshold number of consecutive invalid password entries has been exceeded on said mobile client device.

10. The method of claim 2, wherein said determining step comprises:
determining that the mobile client device is out of compliance when a threshold number of total invalid password entries has been exceeded on said mobile client device.

11. The method of claim 2, wherein said determining step comprises:
determining that said mobile client device is out of compliance when the mobile client device has exceeded a threshold of time without connecting to a network server.

12. The method of claim 2, wherein said determining step comprises:
determining that said mobile client device is out of compliance when said mobile client device has exceeded a threshold of time without undergoing an update session.

13. The method of claim 2, wherein said determining step comprises:
determining that said mobile client device is out of compliance when said mobile client device has exceeded a threshold of time without connecting to a wireless network.

14. A system for securing data stored on a plurality of mobile client devices, comprising:
a security policy definition module configured to define one or more security policies, wherein each of said security policies comprise at least a plurality of security policy parameters;
a storage module configured to store said security policies in a data store;
a policy selection module configured to select one of said security policies for each of said mobile client devices;
a device update module configured to apply said selected security policy to said each of said mobile client devices during an update session for said each of said mobile client devices.

15. A system for securing data stored on a mobile client device, comprising:
a receiving module, configured to receive a security policy at said mobile client device, wherein said security policy comprises at least a plurality of security policy parameters, and wherein said security policy is received from a server having stored therein a plurality of security policies;
a compliance module configured to determine, on said mobile client device, if said mobile client device is in compliance with said selected security policy parameters; and
a data fade module configured to execute data fade actions on said mobile client device when said compliance module determines that said mobile client device is out of compliance with said security policy parameters.

16. The system of claim 15, wherein said data fade module comprises:
a module configured to perform any combination of:
(a) delete all data on said mobile client device;
(b) delete encrypted data on said mobile client device;
(c) delete a previously selected subset data on said mobile client device;
(d) perform a hard reset of said mobile client device;
(e) delete decryption keys on said mobile client device; or
(f) lock said mobile client device, wherein said locking comprises disabling said mobile client device's keyboard, screen, and input devices.

17. The system of claim 16, wherein said module in performing (f) is configured to perform any combination of:
(1) lock said mobile client device until it is contacted by a server;
(2) lock said mobile client device until the device's administrator logs in; or
(3) lock said mobile client device until a one-time challenge-response process has been completed.

18. The system of claim 15, further comprising a device storage module configured to store said selected security policies on said each of the plurality of mobile client devices in a secure manner such that users of said plurality of mobile client devices cannot alter, disable, or delete said selected security policies.

19. The system of claim 18, wherein said device storage module is further configured to encrypt said stored security policies.

20. The system of claim 15, wherein said compliance module is further configured to test said security policy parameters periodically.

21. The system of claim 15, wherein said security policy parameters comprise:
elapsed time since a mobile client device last connected to a server;
elapsed time since said mobile client device has last had an update session;
number of sequential invalid password entries on said mobile client device; and
elapsed time since said mobile client device last connected to a wireless network.

22. A computer program product comprising a computer usable medium having computer program logic recorded thereon for enabling a processor to secure data on a mobile client device, the computer program logic comprising:
defining means for enabling a processor to define one or more security policies, wherein each of said one or more security policies comprises a plurality of security parameters;
storing means for enabling a processor to store said one or more security policies in a data store;
selecting means for enabling a processor to select one of said one or more security policies said mobile client device; and
updating means for enabling a processor to apply said selected security policy to said mobile client device.

23. A computer program comprising a computer usable medium having computer program logic recorded thereon for enabling a processor to secure data on a mobile client device, the computer program logic comprising:
receiving means for enabling a processor to receive a security policy at said mobile client device, wherein said security policy comprises at least a plurality of security policy parameters, and wherein said security policy is received from a server having stored therein a plurality of security policies;
encrypting means for enabling a processor to store a secure copy of said received security policy on said mobile client device;
testing means for enabling a processor to test said plurality of security policy parameters on said mobile client device;
determining means for enabling a processor to determine, on said mobile client device, if said mobile client device is in compliance with said security policy parameters; and
securing means for enabling a processor to execute data fade actions on said mobile client device when said determining means determines that said mobile client device is not in compliance with said selected security policy parameters.

24. The computer program product of claim 23 wherein said securing means is further configured to enable a processor to execute data fade actions on said mobile client device, wherein said data fade actions comprise any combination of (a)-(f):
(a) deleting all data on said mobile client device;
(b) deleting encrypted data on said mobile client device;
(c) deleting a previously selected subset data on said mobile client device;
(d) performing a hard reset of said mobile client device, wherein all data on said mobile client device is deleted and all configuration information on said mobile client device is set back to original factory defaults;
(e) deleting decryption keys on said mobile client device; or
(f) locking said mobile client device, wherein said locking disables said mobile client device's keyboard, screen, and input devices.

25. The computer program product of claim 24, wherein (f) further comprises any combination of (1-3):
(1) locking said mobile client device until it is contacted by a server;
(2) locking said mobile client device until the device's administrator logs in; or
(3) locking said mobile client device until a one-time challenge-response process has been completed.
